(19) United States
(12) Patent Application Publication
(10) Pub. No.: US 2021/0293969 A1
(43) Pub. Date: Sep. 23, 2021

(54) SYSTEM AND METHOD FOR MEASURING EVENT PARAMETERS TO DETECT ANOMALIES IN REAL-TIME

(71) Applicant: ANIRUDHA SURABHI VENKATA JAGANNADHA RAO, Dallas, TX (US)

(72) Inventor: ANIRUDHA SURABHI VENKATA JAGANNADHA RAO, Dallas, TX (US)

(21) Appl. No.: 17/201,168

(22) Filed: Mar. 15, 2021

Related U.S. Application Data
(60) Provisional application No. 62/990,460, filed on Mar. 17, 2020.

(51) Int. Cl. G01S 19/17; G01S 19/26; G08B 21/18

(52) U.S. Cl. CPC G01S 19/17; G08B 21/182; G01S 19/26

(57) ABSTRACT

Exemplary embodiment of the present disclosure directed towards a system for measuring event parameters to detect anomalies in real-time, comprising: an event monitoring unit measures event parameter and detects anomalies of events that occur to a first end user, and vehicle. The event monitoring unit comprises accelerometers to detect sudden increase in acceleration of the first end user and vehicle. gyroscope sensors measure orientation and angular velocity of first end user; and vehicle. A GPS module tracks live location of the first end user; and vehicle. Safe speed trackers track velocity and speed limit. The event monitoring unit triggers emergency protocols automatically to first computing device, and second computing device over network by detecting anomalies of events.

### CROSS-REFERENCE TO RELATED APPLICATIONS

This patent application claims priority benefit of U.S. Provisional Patent Application No. 62/990,460, entitled “System And Method For Measuring Event Parameters To Detect Anomalies In Real-Time”, filed on 17 Mar. 2020. The entire contents of the patent application is hereby incorporated by reference herein in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to safety systems and allied technology. More particularly, the present disclosure relates to a system and method for measuring event parameters to detect anomalies that occur to an end user in real-time thereby sending emergency notifications to emergency responders.

### BACKGROUND

Securing safety of individuals is a major concern. It is very difficult to manage and identify different aspects that can hamper an individual's safety. Particularly, it is very difficult to protect children, senior citizens and/or dependents as they are soft targets for abduction, theft etc. Parents keep worrying about their children's safety and it is difficult for them to locate them if they happen to lose their way etc. It is also very difficult for emergency responders to identify the location of abducted individuals as most people are taken to remote and non-descript locations. There is absolutely no certainty if dependents are unaccompanied, or have been taken outside the safety parameters. It is a fact that when dependents are missing, they may not be detected for a substantial period of time. In such cases, distress signals and calls for help need to be initiated manually in existing systems to send emergency notifications to emergency responders.

In response to the problem of missing persons, there are many existing systems and solutions such as GPS trackers, positioning watches etc. These products are designed with a manual alarm button and a user may set a safe perimeter but beyond this pre-set ranges, these devices are most unhelpful. Further, people are in a state of panic and when they experience unsafe situations or event, dependents are usually unable to raise alarms/signals. Basically, the existing systems allow users to only trigger the alarm button manually and fail to send the notifications to the emergency responders when the user is unable to manually trigger the alarm button. Additionally, when people experience distressing events such as personal attacks, car accidents, kidnapping, near death experiences, the existing systems are powerless as they do not have a provision to automatically detect of the anomalies and judge dangerous situations. The existing systems also fail to track and share users live location to the emergency responders by detecting the anomalies in regular events.

In the light of the aforementioned discussion, there exists a need for a system with novel methodologies that would overcome the above-mentioned challenges.

### SUMMARY

The following presents a simplified summary of the disclosure in order to provide a basic understanding of the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Exemplary embodiments of the present disclosure are directed towards a system and method for measuring event parameters to detect anomalies that occur to the end user in real-time thereby sending emergency notifications to the emergency responders.

An objective of the present disclosure is directed towards sending emergency notifications to a second end user.

Another objective of the present disclosure is directed towards allowing the second end user to track the live location of a first end user.

Another objective of the present disclosure is directed towards measuring the event parameters to detect the anomalies of the events that occur to the first end user.

Another objective of the present disclosure is directed towards triggering emergency protocols, distress signals automatically to the second end users.

Another objective of the present disclosure is directed towards detecting a sudden change in acceleration of a vehicle or change in the geolocation of the vehicle/first end user.

Another objective of the present disclosure is directed towards tracking the speed limit of the vehicle by an event monitoring unit and/or a first computing device.

According to an exemplary aspect, the event monitoring unit configured to measure one or more event parameters and detect one or more anomalies of one or more events that occur to at least one of: a first end user; and a vehicle.

According to another exemplary aspect, the event monitoring unit comprises one or more accelerometers configured to measure change in acceleration of the at least one of: the first end user; and the vehicle.

According to another exemplary aspect, one or more gyroscope sensors configured to measure an orientation and an angular velocity of at least one of: the first end user; and the vehicle.

According to another exemplary aspect, a GPS module configured to track live location of at least one of: the first end user; and the vehicle.

According to another exemplary aspect, the event monitoring unit comprises one or more safe speed trackers and/or the first computing device configured to track velocity and speed limit of at least one of: the vehicle; the first end user, the event monitoring unit configured to trigger one or more emergency protocols automatically to at least one of: a first computing device; and a second computing device; over a network.

### BRIEF DESCRIPTION OF THE DRAWINGS

FIG. 1 is a block diagram depicting a schematic representation of system for measuring event parameters to detect anomalies in real-time, in accordance with one or more exemplary embodiments.

FIG. 2 is a block diagram depicting the event monitoring unit 104 shown in FIG. 1, in accordance with one or more exemplary embodiments.

FIG. 3 is a flowchart depicting an exemplary method of tracking live location of the first end user, in accordance with one or more exemplary embodiments.

FIG. 4 is a flowchart depicting an exemplary method of sending alerts to the first end user and also the second end user when the event parameters exceed the set time limit, in accordance with one or more exemplary embodiments.

FIG. 5 is a flowchart depicting an exemplary method of tracking the speed of the vehicle, in accordance with one or more exemplary embodiments.

FIG. 6 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and so forth, herein do not denote any order, quantity, or importance, but rather are used to distinguish one element from another.

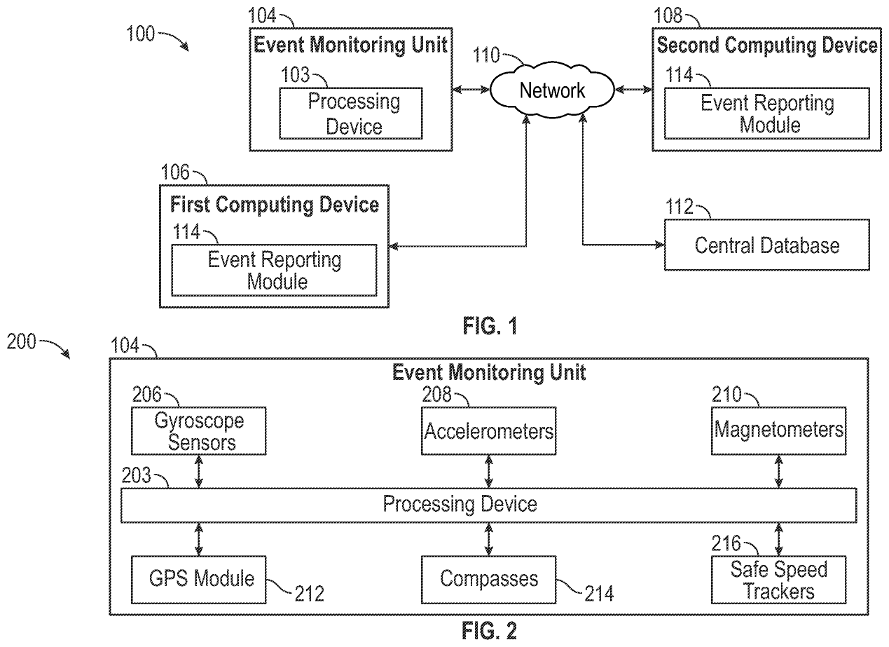

Referring to FIG. 1 is a block diagram 100 depicting a schematic representation of system for measuring event parameters to detect anomalies in real-time, in accordance with one or more exemplary embodiments. The system 100 includes a processing device 103, an event monitoring unit 104, a first computing device 106, a second computing device 108, a network 110, a central database 112, and an event reporting module 114. For example, the event monitoring unit 104 may be integrated in objects. The objects may include, but not limited to, helmet, a head covering device, vehicles, car seats, headbands, head mounting devices, jackets (apparels), apparels, footwear and other accessories, and the like. The head mounting device, headbands may be worn by a first end user. A vehicle may include, but not limited to, a two-wheel vehicle, a three-wheel vehicle, a four-wheel vehicle, motorcycles, small bikes, especially electric cycles and so forth. The event monitoring unit 104 may also be known as inertial measurement unit (IMU). The first end user may include, but not limited to, a child, a driver, an athlete, a motorist, a passenger, a vehicle owner, a vehicle user, an individual, and so forth. The network 110 may include but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

The processing device 103 may include but not limited to, a microcontroller (for example ARM 7 or ARM 11), a raspberry pi3 or a Pine 64 or any other 64 bit processor which can run Linux OS, a microprocessor, a digital signal processor, a microcomputer, a field programmable gate array, a programmable logic device, a state machine or logic circuitry, Arduino board. The processing device 103 may be programmed with anti-kidnapping protocol techniques, home by dinner protocol techniques, and so forth. The anti-kidnapping protocols and the home by dinner protocols may be software techniques.

Although the first and second computing devices 106, 108 are shown in FIG. 1, an embodiment of the system 100 may support any number of computing devices. Each computing device supported by the system 100 is realized as a computer-implemented or computer-based device having the hardware or firmware, software, and/or processing logic needed to carry out the intelligent messaging techniques and computer-implemented methodologies described in more detail herein.

The event reporting module 114, may be accessed as mobile applications, web applications, software that offers the functionality of accessing mobile applications, and viewing/processing of interactive pages, for example, are implemented in the first and second computing devices 106, 108 as will be apparent to one skilled in the relevant arts by reading the disclosure provided herein. The event reporting module 114 may be downloaded from the cloud server (not shown). For example, the event reporting module 114 may be any suitable applications downloaded from, GOOGLE PLAY® (for Google Android devices), Apple Inc.'s APP STORE® (for Apple devices, or any other suitable database). In some embodiments, the event reporting module 114 may be software, firmware, or hardware that is integrated into the first and second computing devices 106, 108. The event reporting module 114 may include anti-kidnapping protocol techniques, home by dinner protocol techniques, and so forth.

The first computing device 106 and the second computing device 108 may be operatively coupled to each other through the network 110. The first and second computing devices 106 and 108 may include but not limited to, a computer workstation, an interactive kiosk, and a personal mobile computing device such as a digital assistant, a mobile phone, a laptop, and storage devices, backend servers hosting the database and other software and so forth. The first computing device 106 may be operated by a first end user. The second computing device 108 may be operated by a second end user. The second end user may include, but not limited to, emergency responders, parents, guardians, medical professionals, medical examiners, emergency authority medical practitioners, doctors, physicians, family members, friends, relatives, neighbours, emergency service providers, and so forth.

The event monitoring unit 104 may be electrically coupled to the processing device 103 and is configured to measure the event parameters to detect the anomalies of the events that occur to the first end user. The event monitoring unit 104 may be configured to detect and track the motion of the vehicle/first end user in a three-dimensional space. The event monitoring unit 104 may be configured to measure change in acceleration of the vehicle or change in geo location of the vehicle/first end user. The event monitoring unit 104 may be configured to trigger the emergency protocols automatically to the second computing device 108.

The event parameters may include, but not limited to, current location, velocity, speed limit, distance, acceleration and perimeter range, mode of transport, network connectivity, and so forth. The events may include, but not limited to, non-accidental emergency events relating to the vehicle (e.g., a theft of the vehicle), or emergency events relating specifically to the occupant(s) of the vehicle (e.g., a medical impairment of an occupant of the vehicle, a kidnapping or assault of an occupant of the vehicle, etc.).

The event reporting module 114 may be configured to establish a communication between the event monitoring unit 104 and the first computing device 106 or the second computing device 108 through the network 110. Once the communication is established, the event reporting module 114 may be configured to activate the emergency protocols through the network 110. The emergency protocols may include, distress signals, emergency notifications, emergency alerts, emergency alarms and so forth. The emergency protocols may be automatically generated by the event reporting module 114 when the anomalies of events are detected. The event monitoring unit 104 may be configured to detect the anomalies of the events by measuring the event parameters. The event reporting module 114 may be configured to receive the anomalies (irregularities) of the events detected by the event monitoring unit 104 via the network 110.

The head mounting device may also include a wireless communication device, a microphone, speakers positioned on the left side and right side of the user's head, front output LED lights rear output LED light, ultrasonic sensors, buttons, pressure sensors, a left vibration sensor, and a right vibration sensor. The head mounting device may include a network module. The network module may be electrically coupled to the processing device 103 and is configured to connect the event monitoring unit 104 with the first computing device 106. The network module may be configured to send the emergency notifications to the second end users. The emergency notifications may include but not limited to, SMS, alerts, email, warnings, and so forth. The central database 112 may be configured to store the event parameters measured by the event monitoring unit 104.

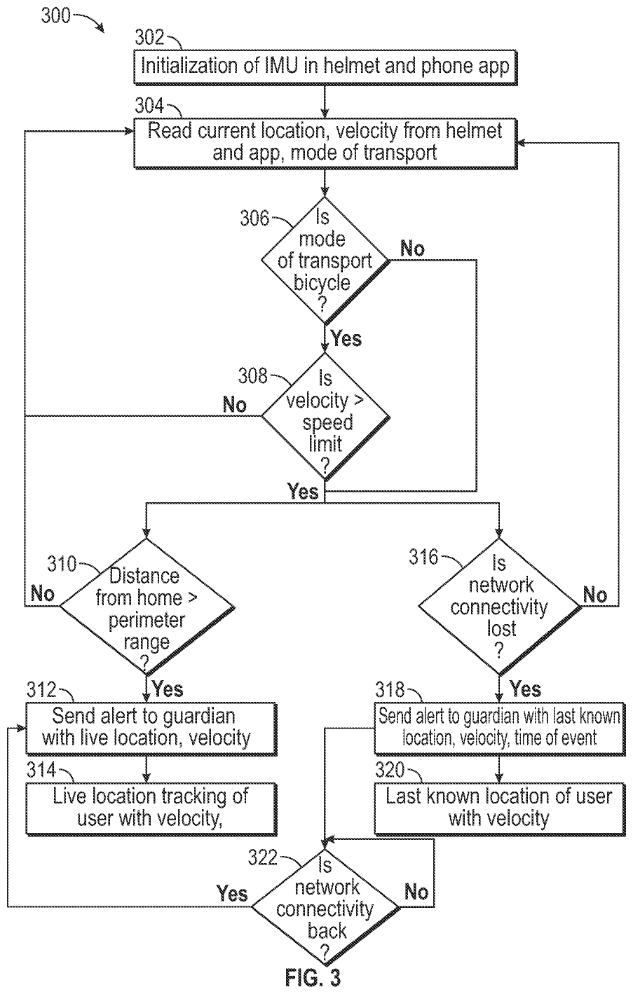

Referring to FIG. 2 is a block diagram 200 depicting the event monitoring unit 104 shown in FIG. 1, in accordance with one or more exemplary embodiments. The event monitoring unit 104 includes a processing device 203, one or more gyroscope sensors 206, one or more accelerometers 208, one or more magnetometers 210, a GPS module 212, one or more compasses 214, and one or more safe speed trackers 216. The event monitoring unit 104 may be electrically coupled to the processing device 203 and is configured to measure the event parameters to detect the anomalies that occur to the first end user in real-time. The one or more gyroscope sensors 206 may be electrically coupled to the processing device 203 and is configured to measure the orientation and angular velocity of the head mounting device. The one or more accelerometers 208 may be electrically coupled to the processing device 203 and is configured to measure the acceleration (movement and motion) of the head mounting device. The one or more magnetometers 210 may be electrically coupled to the processing device 203 and is configured to track the position or change in geo location of the head mounting device. The GPS module 212 may be electrically coupled to the processing device 203 and is configured to track the live location of the second end user. The one or more compasses 214 may be configured to determine the compass direction that corresponds to the orientation of the integrated position and direction the head mounting device. The GPS module 212 and the one or more safe speed trackers 216 may be electrically coupled to the processing device 203 and are configured to track the velocity, speed limit of the vehicle. (For example, tracking whether the velocity, and the current speed is greater than speed limit).

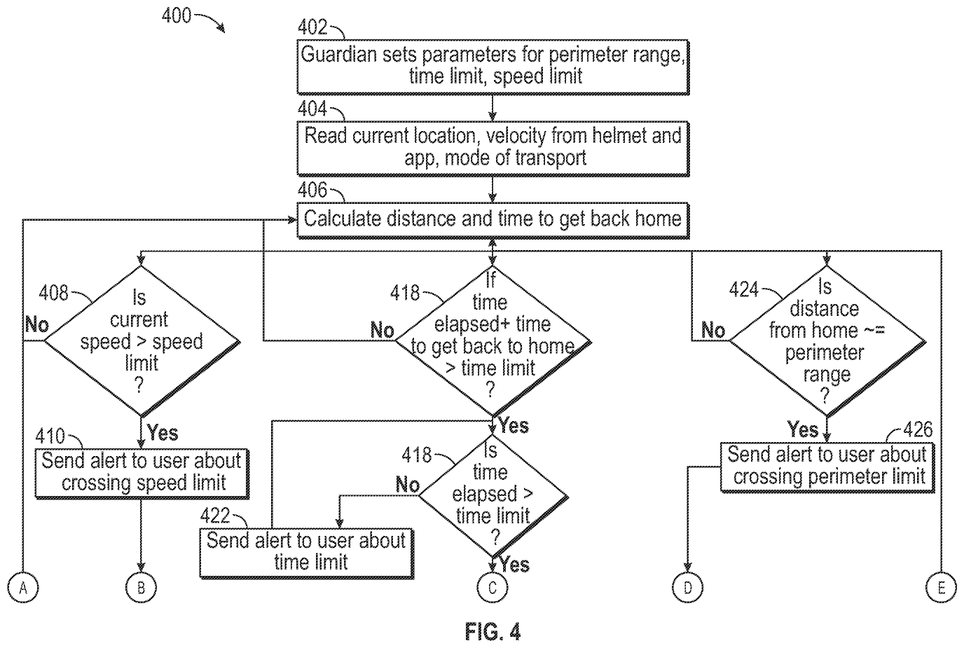

Referring to FIG. 3 is a flowchart 300 depicting an exemplary method of tracking the live location of the first end user, in accordance with one or more exemplary embodiments. The exemplary method 300 includes an anti-kidnapping protocol. As an option, the method 300 is carried out in the context of the details of FIG. 1, and FIG. 2. However, the method 300 is carried out in any desired environment. Further, the aforementioned definitions are equally applied to the description below.

The method commences at step 302, with establishing the communication between the event monitoring unit and the head mounting device through the event reporting module. Thereafter at step 304, reading the event parameters by the event reporting module to detect anomalies of the events occurs. Determining whether the mode of transport is by a bicycle, at step 306. If the answer at step 306 is YES, the method continues at step 308, determining whether the velocity is greater than the speed limit using the safe speed tracker. If the answer at step 308 is YES, the method continues at step 310, determining whether the distance form is greater than the perimeter range. If the answer at step 310 is YES, the method continues at step 312, sending alert to the second end user with the live location and velocity. Thereafter at step 314, tracking the live location of the first end user with the velocity by the second end user. If the answer at step 310 is NO, the method reverts to step 304. If the answer at step 308 is YES, the method continues at step 316, determining whether the network connectivity is lost. If the answer at step 316 is YES, the method continues at step 318, sending alert to the second end user with the last known location, velocity, time of the event. Thereafter at step 320, sending the last known location of the first end user with velocity to the second end user. Thereafter at step 318, determining whether the network connectivity is back, at step 322. If the answer at step 322 is YES, the method reverts to step 312. If the answer at step 322 is NO, the method reverts to step 318. If the answer at step 308 is NO, the method reverts at step 304. If the answer at step 306 is NO, the method reverts at step 310, 316. If the answer at step 316 is NO, the method reverts at step 304.

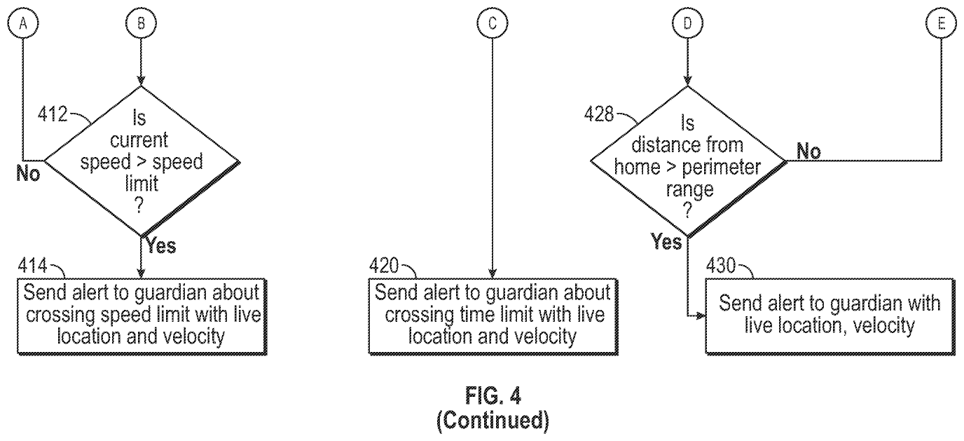

Referring to FIG. 4 is a flowchart 400 depicting an exemplary method of sending alerts to the first end user and also the second end user when the event parameters exceed the set time limit, in accordance with one or more exemplary embodiments. The exemplary method 400 includes a dinner protocol. As an option, the method 400 is carried out in the context of the details of FIG. 1, FIG. 2, and FIG. 3. However, the method 400 is carried out in any desired environment. Further, the aforementioned definitions are equally applied to the description below.

The method commences at step 402, setting event parameters in the event reporting module on the computing device by the second end user. Thereafter, at step 404, reading real-time current location, velocity from the head mounting device and the mode of transport by the event reporting module. Thereafter, at step 406, calculating distance and time by the event reporting module to get back home. Thereafter, at step 408, determining whether the current speed is greater than set speed limit by the safe speed tracker? If the answer to step 408 is YES, the exemplary method continues at step 410, sending alerts to the first computing device about crossing the speed limit. If the answer to step 408 is NO, then the exemplary method reverts to step 406. At step 412, Determining whether the current speed is greater than set speed limit by the safe speed tracker? If the answer to step 412 is YES, then the method continues at step 414, sending alerts to the second computing device about crossing the speed limit with live location and velocity. If the answer to step 412 is NO, then the exemplary method reverts to step 406. Thereafter, at step 416, determining whether the elapsed time, time to get back home is greater than the set time limit. If the answer to step 416 is YES, then the method continues at step 418, determining whether the time is elapsed greater than the set time limit? If the answer to step 418 is YES, the exemplary method continues at step 420, sending alerts to the second computing device about crossing time limit with live location and velocity. If the answer to step 418 is NO, the exemplary method continues at step 422, sending alerts to the first computing device about time limit. If the answer to step 416 is NO, then the exemplary method reverts to step 406. Thereafter, at step 424, determining whether the distance from home is approximately equal to the perimeter range? If the answer to step 424 is YES, then the exemplary method continues at step 426, sending alerts to the first computing device about crossing the perimeter limit. If the answer to step 424 is NO, then the exemplary method reverts to step 406. Thereafter, at step 428, determining whether the distance from home is greater than the perimeter range? If the answer to step 428 is YES, then the exemplary method continues at step 430, sending alerts to the second computing device with live location and velocity. If the answer to step 428 is NO, then the exemplary method continues at step 406.

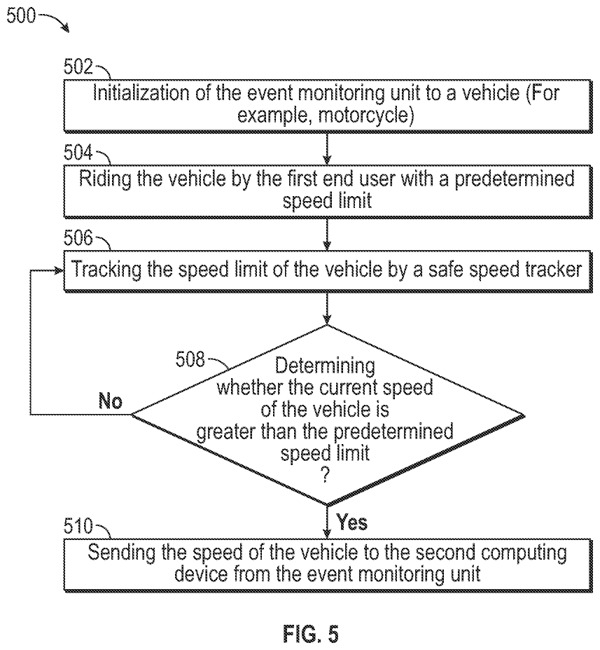

Referring to FIG. 5 is a flowchart 500 depicting an exemplary method of tracking the speed of the vehicle, in accordance with one or more exemplary embodiments. As an option, the method 500 is carried out in the context of the details of FIG. 1, FIG. 2, FIG. 3 and FIG. 4. However, the method 500 is carried out in any desired environment. Further, the aforementioned definitions are equally applied to the description below.

The method commences at step 502, initialization of the event monitoring unit to the vehicle (For example, motorcycle). Thereafter, at step 504, riding the vehicle by the first end user with a predetermined speed limit. For example, the predetermined speed limit is determined by the second end user (parent/guardian). Thereafter, at step 506, tracking the speed limit of the vehicle by the safe speed tracker. Thereafter, at step 508, determining whether the current speed of the vehicle is greater than the predetermined speed limit? If answer to step 508 is YES, then the exemplary method continues at step 510, sending the speed of the vehicle to the second computing device from the event monitoring unit. If answer to step 508 is NO, then the exemplary method reverts to step 506.

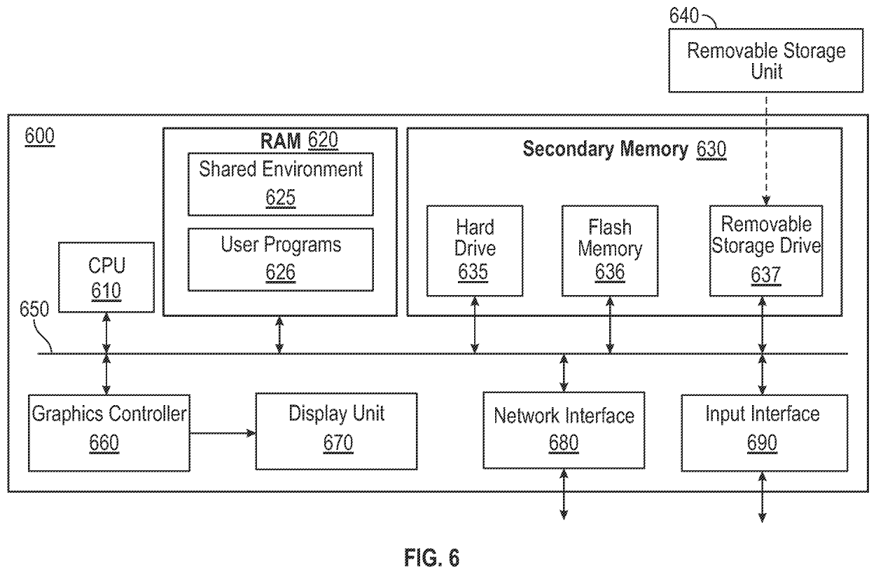

Referring to FIG. 6 is a block diagram 600 illustrating the details of a digital processing system 600 in which various aspects of the present disclosure are operative by execution of appropriate software instructions. The Digital processing system 600 may correspond to the computing devices 106, 108 (or any other system in which the various features disclosed above can be implemented).

Digital processing system 600 may contain one or more processors such as a central processing unit (CPU) 610, random access memory (RAM) 620, secondary memory 627, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 820 is shown currently containing software instructions, such as those used in threads and stacks, constituting shared environment 625 and/or user programs 626. Shared environment 625 includes operating systems, device drivers, virtual machines, etc., which provide a (common) run time environment for execution of user programs 626.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems (such as those shown in FIG. 1) connected to the network 110.

Secondary memory 630 may contain hard drive 635, flash memory 636, and removable storage drive 637. Secondary memory 630 may store the data software instructions (e.g., for performing the actions noted above with respect to the Figures), which enable digital processing system 600 to provide several features in accordance with the present disclosure.

Some or all of the data and instructions may be provided on removable storage unit 640, and the data and instructions may be read and provided by removable storage drive 637 to CPU 610. Floppy drive, magnetic tape drive, CD-ROM drive, DVD Drive, Flash memory, removable memory chip (PCMCIA Card, EEPROM) are examples of such removable storage drive 637.

Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for measuring event parameters to detect anomalies in real-time, comprising:
an event monitoring unit configured to measure one or more event parameters and detect one or more anomalies of one or more events that occur to at least one of: a first end user; and a vehicle; the event monitoring unit comprises one or more accelerometers configured to detect change in acceleration of the at least one of: the first end user; and the vehicle;
one or more gyroscope sensors configured to measure an orientation and an angular velocity of at least one of: the first end user; and the vehicle;
a GPS module configured to track a live location of at least one of: the first end user; and the vehicle; and
one or more safe speed trackers and the GPS module configured to track velocity and speed limit of at least one of: the vehicle; the first end user, the event monitoring unit configured to trigger one or more emergency protocols automatically to at least one of: a first computing device; and a second computing device; over a network by detecting the one or more anomalies of the one or more events.

2. The system of claim 1, wherein the one or more accelerometers, the one or more gyroscope sensors, one or more magnetometers, and the GPS module are configured to track at least one of: position; change in geo location; of at least one of: the vehicle; and the first end user.

3. The system of claim 1, wherein the event monitoring unit is integrated in one or more objects.

4. The system of claim 1, wherein the event monitoring unit is configured to detect and track the motion of at least one of the vehicle; and the first end user in a three-dimensional space.

5. The system of claim 1, wherein the first computing device and the second computing device comprise an event reporting module configured to analyze the one or more event parameters of the one or more anomalies.

6. The system of claim 5, wherein the event reporting module is configured to establish a communication between the event monitoring unit and at least one of: the first computing device; and the second computing device; through the network.

7. The system of claim 5, wherein the event reporting module is configured to receive the one or more anomalies (irregularities) of the one or more events detected by the event monitoring unit through the network.

8. The system of claim 1, wherein the event monitoring unit comprises one or more compasses configured to determine compass direction that corresponds to an orientation of an integrated position and direction of the at least one of: the vehicle; and the first end user.

9. The system of claim 1, further comprises a central database configured to store the one or more event parameters measured by the event monitoring unit.

10. The system of claim 1, wherein the one or more emergency protocols comprises one or more emergency notifications, one or more emergency alerts, and one or more distress signals.

11. The system of claim 1, wherein the one or more event parameters comprises a current location, velocity, speed limit, distance, an acceleration and a perimeter range, a mode of transport, and a network connectivity.

12. A method for measuring event parameters to detect anomalies in real-time, comprising:
establishing communication between an event monitoring unit with at least one of: a first computing device; and a second computing device through a network/satellite;
tracking motion, velocity and speed limit of at least one of: a vehicle; and a first end-user;
detecting one or more anomalies of one or more events that occur to at least one of: the vehicle; the first end user by identifying change in acceleration of at least one of: the vehicle or change in geo location of at least one of: the vehicle; and the first end user; and
triggering one or more emergency protocols to at least one of: the first computing device; and the second computing device from an event reporting module through a network.

13. The method of claim 12, further comprising a step of setting one or more event parameters in the event reporting module on the first computing device by the second end user.

14. The method of claim 12, further comprising a step of reading real-time current location, velocity from at least one of: one or more objects; vehicle; and a mode of transport; by the event reporting module.

15. The method of claim 12, further comprising a step of calculating one or more event parameters of the first end user by the event reporting module.

16. The method of claim 12, further comprising a step of sending one or more alerts to the first computing device and the second computing device regarding a speed limit with live location and velocity regarding a perimeter limit.
